(19) United States
(12) Patent Application Publication
(10) Pub. No.: US 2025/0189049 A1
(43) Pub. Date: Jun. 12, 2025

(54) CHECK VALVE

(71) Applicant: TI Automotive Technology Center GmbH, Rastatt (DE)

(72) Inventors: Albert BOECKER, Ettlingen (DE); Matthias WINTER, Rastatt (DE); Artem TUZIN, Stutensee (DE); Thorsten SCHAEFER, Steinfeld (DE); Florian DEIBEL, Sinzheim (DE)

(21) Appl. No.: 18/532,626

(22) Filed: Dec. 7, 2023

(51) Int. Cl. F16K 15/04; F16K 15/03

(52) U.S. Cl. CPC F16K 15/044; F16K 15/03

(57) ABSTRACT

A check valve having a flow channel and at least one blocking body, wherein the blocking body is arranged movably in the flow channel. A retaining element and a blocking body seat are arranged in the flow channel, wherein the retaining element limits a movement of the blocking body, wherein the blocking body moves into a blocking position in a first flow direction of the fluid, so that the blocking body rests against the blocking body seat in a sealing manner and closes the flow channel. The blocking body also moves in a second flow direction of the fluid into a passage position and opens the flow channel. The flow channel extends at least around the blocking body, the retaining element and the blocking body seat, and is formed in one piece and in a materially integral manner.

### RELATED APPLICATIONS

The present disclosure is a national phase application of European Application 22212293.9, filed on Dec. 8, 2023, the entire contents of which is incorporated herein by reference.

### FIELD

The present disclosure relates to a check valve comprising a flow channel through which a fluid can flow and at least one blocking body, wherein the blocking body is arranged movably in the flow channel, wherein the blocking body can be moved between a blocking position and at least one passage position. The disclosure further relates to a pipe having a check valve.

### BACKGROUND

Check valves are generally known and are used, for example, in fluid circuits, wherein fluid circuits are understood to be, in particular, cooling circuits and air-conditioning circuits in which a coolant or a refrigerant circulates. Check valves allow fluid to flow through the flow channel in one direction only and block a fluid flow in the opposite direction. This can, for example, prevent fluid from flowing back when units are switched off. Furthermore, check valves can be used to direct fluid flows in more complex fluid circuits.

One area of application for check valves is in temperature control circuits in the field of electromobility. To achieve a high range for electric vehicles, for example, it is necessary to control the temperature of electrical components. The components of electric vehicles whose temperature needs to be controlled are, in particular, electrical energy storage units, but also the power electronics or connectors of fast-charging devices. An electrical energy storage device only has a best possible capacity in a very small temperature spectrum. Therefore, it is necessary to heat electrical energy storage devices of electric vehicles at low ambient temperatures and to cool them at high outside temperatures or during high load changes.

### BRIEF SUMMARY

The present disclosure provides a check valve that can be manufactured inexpensively.

The check valve according to the disclosure includes a flow channel through which a fluid can flow and at least one blocking body, wherein the blocking body is arranged movably in the flow channel, wherein the blocking body can be moved between a blocking position and a passage position, wherein a retaining element and a blocking body seat are arranged in the flow channel, wherein the retaining element limits a movement of the blocking body, wherein the blocking body moves in a first flow direction of the fluid into the blocking position, so that the blocking body rests against the blocking body seat in a sealing manner and closes the flow channel, and wherein the blocking body moves in a second flow direction of the fluid into the passage position and opens the flow channel, wherein the flow channel extends at least around the blocking body, the retaining element and the blocking body seat and is formed in one piece and in a materially integral manner.

Forming the flow channel in one piece and in a materially integral manner allows the flow channel to be formed from just one component. The blocking body, the retaining element and the blocking body seat are preferably inserted directly into the flow channel or into the preform of the flow channel during manufacture of the flow channel. The blocking body, the retaining element and the blocking body seat are integrated into the flow channel. So far, the housings of check valves have been formed from several parts, wherein the housing is closed after assembly of the blocking body. Due to the one-piece design of the flow channel according to the disclosure, the tightness of the flow channel can be improved, in particular a separate connection of flow channel elements for subsequent opening and closing of the flow channel can be avoided. In addition, the number of individual components required to manufacture the check valve is reduced. The check valve according to the disclosure has a compact form and the components are connected to each other in a loss-proof manner, thus reducing the assembly effort. This allows the check valve to be manufactured and assembled in high volumes inexpensively.

The blocking body is arranged movably in the flow channel, wherein the blocking body is moved by a pressure difference of the fluid flowing through the flow channel. Depending on the flow direction, different pressure differences can exist on opposite sides of the blocking body, so that the blocking body can be moved to the blocking position or the passage position. In the passage position, the blocking body is spaced from the blocking body seat, so that fluid can flow through the flow channel. The movement of the blocking body is limited by the retaining element. The blocking body can rest against the retaining element in an end position, so that the open flow cross-section allows the maximum volume flow of the fluid. This also depends on the design of the retaining element. The retaining element can limit the blocking body especially in the longitudinal direction of the flow channel.

The blocking body can have a spherical form. Due to a spherical form, the blocking body is independent of orientation. In addition, the risk of jamming can be reduced, and operational safety increased. Also, the mountability is improved.

However, other geometric embodiments are also conceivable. For example, the blocking body can be disk-shaped, umbrella-shaped, flap-shaped, cone-shaped, shaped as paraboloids, as ellipsoids. In addition, the blocking body can be flow-optimized and equipped, for example, with guide vanes or other elements for stabilization. Geometric embodiments whose cross-section tapers in the longitudinal direction of the flow channel in the direction of the blocking body seat are advantageous. This can support self-centering of the blocking body when it moves to the blocking position and prevent the blocking body from jamming, thereby reducing the susceptibility of the check valve to faults and thus also further improving its manageability.

The blocking body seat can include an opening and a sealing surface extending around the opening. The blocking body and blocking body seat can have sealing surfaces that are congruent with one another, wherein, in the blocking position, the sealing surface of the blocking body rests against the sealing surface of the blocking body seat in a sealing manner thus closing the opening. In the passage position, the blocking body is spaced apart from the sealing edge, thereby opening the opening.

The flow channel can be formed as a blow-molded part. Blow molding allows producing a flow channel with a complex shape. For example, the flow channel can be formed in the shape required for the mounting location, e.g., curved. Furthermore, it is particularly easy to mold cross-sectional changes into the flow channel. For example, sections of the flow channel can be circular, whereas other sections of the flow channel can be non-circular, e.g., oval or rectangular. This allows the flow channel to be formed in a particularly space-saving manner and adapted to the mounting location. The blocking body, the retaining element and the blocking body seat can be inserted as prefabricated components into the preform forming the flow channel, and then the flow channel can be formed by blow molding. As a result, the blocking body, the retaining element and the blocking body seat are integrated directly into the flow channel, so that the mounting of the check valve is simple and inexpensive. The flow channel can be manufactured in one piece in a materially integral manner using blow molding, which is particularly simple and inexpensive. The flow channel can preferably be made of a polymeric material. Depending on the ambient conditions and the requirements of the fluid to be transported, the wall of the flow channel can be single-layered or multi-layered. In the case of a multi-layered embodiment, the wall of the flow channel can be formed from a plastic compound and can comprise several different plastics.

In a first embodiment, at least one restoring spring can be assigned to the blocking body, the restoring spring being designed to exert a restoring force on the blocking body, wherein the restoring force acts in the direction of the blocking body seat. The restoring spring can be formed to automatically press the blocking body against the blocking body seat, so that the first flow direction is blocked for the fluid. The restoring force can improve the tightness in the first flow direction. In the second flow direction, the fluid can flow through the flow channel provided that the differential pressure of the fluid is so high that the blocking body moves away from the blocking body seat against the restoring force of the restoring spring. The restoring force depends on the dimensioning of the spring.

Alternatively, it is also conceivable to achieve the restoring force through gravity on the blocking body by means of a corresponding arrangement of the check valve. In such a case, it is advantageous that the restoring spring can be omitted.

The restoring spring can be formed from plastic. The advantage here is that plastics are corrosion-resistant and inexpensive. This is particularly advantageous in connection with applications in electromobility. In the case of storage batteries, it is possible that electrolyte may enter the cooling circuit in the event of damage. The plastic restoring spring can be made of a plastic that is resistant to such electrolytes. Alternatively, it is also conceivable to achieve the restoring force through gravity by means of a corresponding arrangement of the check valve.

The retaining element and/or the blocking body seat can be formed in one piece and in a materially integral manner from the flow channel. In this case, the retaining element and/or the blocking body seat can be formed in one piece and in a materially integral manner from a shell or surface of the flow channel. Preferably, the retaining element is formed in one piece and in a materially integral manner from the flow channel. Particularly preferably, the retaining element and the blocking body seat are formed from the flow channel. In this embodiment, only two components are required to provide the check valve: the flow channel and the blocking body. This results in a particularly inexpensive check valve. During the manufacturing process, the blocking body is arranged in the flow channel, wherein the blocking body is arranged in a movable and loss-proof manner in the flow channel. By reducing the number of components required, maintenance, mounting and manageability of the check valve are improved.

The retaining element can have at least one projection projecting into the interior of the flow channel. In the passage position, the blocking body can rest against the projection, so that the projection limits the movement of the blocking body. In particular, the projection can limit the movement of the blocking body in the longitudinal direction of the flow channel. Preferably, the retaining element has a plurality of projections projecting into the interior of the flow channel, in particular at least three projections. The projections can be distributed around the circumference, preferably evenly distributed around the circumference.

It is also conceivable that the retaining element is formed as a collar projecting into the interior of the flow channel. In this case, the collar has openings through which the fluid can flow. Preferably, the collar is arranged circumferentially. In particular, when the blocking body rests against the retaining element, the fluid can flow through the openings.

The blocking body seat can have a circumferential sealing projection projecting into the interior of the flow channel. In the blocking position, the blocking body rests against the sealing projection in a sealing manner, preventing the fluid from passing through the check valve.

The check valve can comprise a cage, wherein the cage comprises the retaining element. Preferably, the cage is fixed in the flow channel. For this purpose, the cage can be attached to the flow channel form-fittingly or in a materially bond. In particular, the cage can be welded to the flow channel. It is also conceivable that the cage is connected to the flow channel via a materially bond by blow molding the flow channel.

The cage can form the blocking body seat. Preferably, the connection between the cage and the flow channel is in a sealing manner, so that no fluid can pass between the outside of the cage and the inside of the flow channel, at least in the area of the blocking body seat. This can reduce the risk of a bypass flow. The blocking body seat can be annular-shaped.

The cage can form a separate component, which is inserted into the flow channel. Preferably, the cage is inserted into the flow channel during the manufacturing process of the flow channel. As a result, the cage is arranged in a loss-proof manner in the flow channel. The cage can be inserted into the flow channel preform and then the flow channel can be formed by blow molding, so that the cage is firmly integrated into the flow channel.

The cage can accommodate the blocking body, wherein the cage and the blocking body can form a mountable structural unit. The structural unit can be formed as an insert. Inserts are components which are formed separately to a hollow body, wherein the insert can be placed in the hollow body. The insert is inserted into the flow channel during the manufacturing process of the flow channel. In particular, when the flow channel is manufactured by the blow molding process, the insert can be inserted in the blow mold before the blow molding process and fixed to the flow channel during the blow molding process.

The cage can have at least one guide section formed to restrict a movement of the blocking body. Preferably, a movement of the blocking body in the longitudinal direction of the flow channel is guided by means of the guide section. The guide section can reduce the risk of jamming and/or radial deviation of the blocking body relative to the blocking body seat. Preferably, the cage has at least two guide sections. The guided movement of the blocking body into the blocking position supports a resting of the blocking body against the blocking body seat in a sealing manner. This improves the tightness of the check valve. Preferably, the blocking body form-fittingly engages the guide section to form a guide between the blocking body and the cage.

The blocking body can be hingedly connected to the cage. The hinge joint is preferably formed, so that the blocking body can be swung from the blocking position to the passage position and back. In particular, the blocking body can be formed as a flap.

The object of the present disclosure is also achieved by a pipe with a check valve as described, wherein the pipe and the flow channel are formed in a materially integral manner and on one piece. The pipe can have connections, such as couplings or quick connectors, for connecting components, so that the components are flow-connected when the blocking body is in the passage position. The pipe can be formed as an elongated hollow body, wherein the simple shape of the check valve according to the disclosure also permits more complex pipe geometries, for example the embodiment of two elongated pipe sections with a pipe bend in between.

Furthermore, it is conceivable that several pipes are connected to form a pipe arrangement. The pipe arrangement can be formed as a pipe bundle, wherein the pipe bundle can be formed in one piece and in a materially integral manner. In particular, the pipe, the pipe arrangement, and the pipe bundle can be designed as blow-molded parts.

Separate connection points between a check valve and the flow channel can be omitted with such a design. By reducing possible leakage points, the tightness can be improved. In addition, further assembly steps can be eliminated during final assembly, which improves manageability. The check valve can be formed in a section of the pipe.

The object of the present disclosure is also achieved by a temperature control circuit with at least one check valve described and/or at least one pipe described. The temperature control circuit can be integrated into the electric motor drive of an electric vehicle and transport temperature control medium. The temperature control circuit can be used to control the temperature of electrical components in order to achieve high ranges in the field of electromobility.

### BRIEF DESCRIPTION OF THE DRAWINGS

One embodiment of the check valve according to the disclosure is explained in more detail below with reference to the figures. These show, each schematically:

FIG. 1 a first embodiment of a check valve in passage position;

FIG. 2 a sectional view of the check valve from FIG. 1 in passage position;

FIG. 3 a sectional view of the check valve from FIG. 1 in blocking position;

FIG. 4 a second embodiment of a check valve in passage position;

FIG. 5 a sectional view of the check valve from FIG. 4 in passage position;

FIG. 6 a sectional view of the check valve from FIG. 4 in blocking position;

FIG. 7 a third embodiment of a check valve in passage position;

FIG. 8 a sectional view of the check valve from FIG. 7 in passage position;

FIG. 9 a sectional view of the check valve from FIG. 7 in blocking position;

FIG. 10 a sectional view of a fourth embodiment of a check valve in passage position;

FIG. 11 a sectional view of the check valve from FIG. 10 in blocking position.

### DETAILED DESCRIPTION

The figures show a check valve 1, comprising a flow channel 2 through which a fluid can flow and a blocking body 3. The check valve 1 forms part of a temperature control circuit for transporting temperature control medium. Specifically, the check valve is integrated into a temperature control circuit of an electric motor drive of an electric vehicle. The check valve 1 allows flow of the medium fed into the temperature control circuit in one flow direction only and largely blocks flow in the opposite direction.

The check valve 1 is integrated into the pipe of a pipe arrangement. In this case, the flow channel 2 is part of the pipe. The pipe arrangement connects components of a temperature control circuit.

The blocking body 3 is arranged movably in the flow channel 2 and is movable between a blocking position and at least one passage position. A retaining element 4 and a blocking body seat 5 are arranged in the flow channel 2. The retaining element 4 limits a movement of the blocking body 3. The blocking body 3 moves into the blocking position in a first flow direction of the fluid, so that the blocking body 3 rests against the blocking body seat 5 in a sealing manner and closes the flow channel 2. The blocking body 3 moves in a second flow direction of the fluid into the passage position and opens the flow channel 2. The flow channel 2 extends at least around the blocking body 3, the retaining element 4 and the blocking body seat 5 and is formed in one piece and in a materially integral manner.

The flow channel 2 is formed as a materially integral and one-piece component. The blocking body 3, the retaining element 4 and the blocking body seat 5 are inserted into the flow channel 2 during the forming of the flow channel 2, so that an opening of the flow channel 2 after its manufacture can be avoided. The blocking body 3, the retaining element 4 and the blocking body seat 5 are thus integrated into the flow channel 2.

The flow channel 2 is formed as a rotationally symmetrical blow-molded part made of polymeric material. The flow channel 2 comprises an inlet opening and an outlet opening, wherein the inlet opening and the outlet opening are flow-connected in the passage position.

The blocking body 3 is movable by a pressure difference of the fluid flowing through the flow channel 2. Depending on the flow direction, different pressure differences can exist at the blocking body 3, so that the blocking body 3 can be moved to the blocking position or the passage position. In the passage position, the blocking body 3 is spaced from the blocking body seat 5, so that fluid can flow through the flow channel 2. In the passage position of the blocking body 3 facing away from the blocking body seat 5, the blocking body 3 rests against the retaining element 4, thereby limiting the movement of the blocking body 3.

The blocking body seat 5 includes an opening and a sealing surface extending around the opening. Blocking body 3 and blocking body seat 5 have sealing surfaces that are congruent with one another, wherein, in the blocking position, the sealing surface of the blocking body 3 rests against the sealing surface of the blocking body seat 5 in a sealing manner thus closing the opening. In the passage position, the blocking body 3 is spaced apart from the sealing edge, thereby opening the opening.

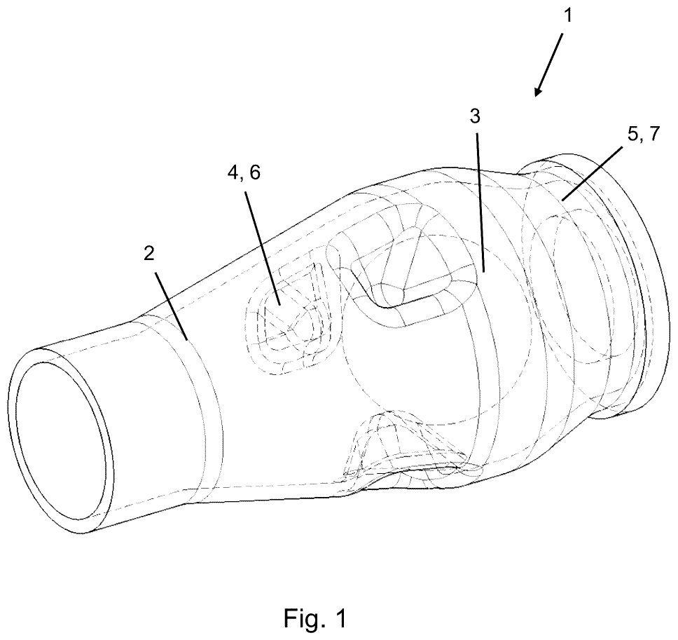

FIGS. 1 to 3 show a first embodiment of a check valve 1. In this embodiment, the blocking body 3 has a spherical form. The retaining element 4 and the blocking body seat 5 are formed from the flow channel 2 in one piece and in a materially integral manner. In this case, the retaining element 4 and the blocking body seat 5 are formed from a lateral surface of the flow channel 2 in one piece and in a materially integral manner. The blocking body 3 is arranged in a movable and loss-proof manner in the flow channel 2.

The retaining element 4 has three projections 6 projecting into the interior of the flow channel 2. The projections 6 are evenly distributed around the circumference. In the outermost passage position of the blocking body 3 facing away from the blocking body seat 5, the blocking body 3 rests against the projections 6, so that the movement of the blocking body 3 in the longitudinal direction of the flow channel 2 is limited.

The blocking body seat 5 has a circumferential sealing projection 7 projecting into the interior of the flow channel 2. In the blocking position, the blocking body 3 rests against the sealing projection 7 in a sealing manner, preventing the fluid from passing through the check valve 1.

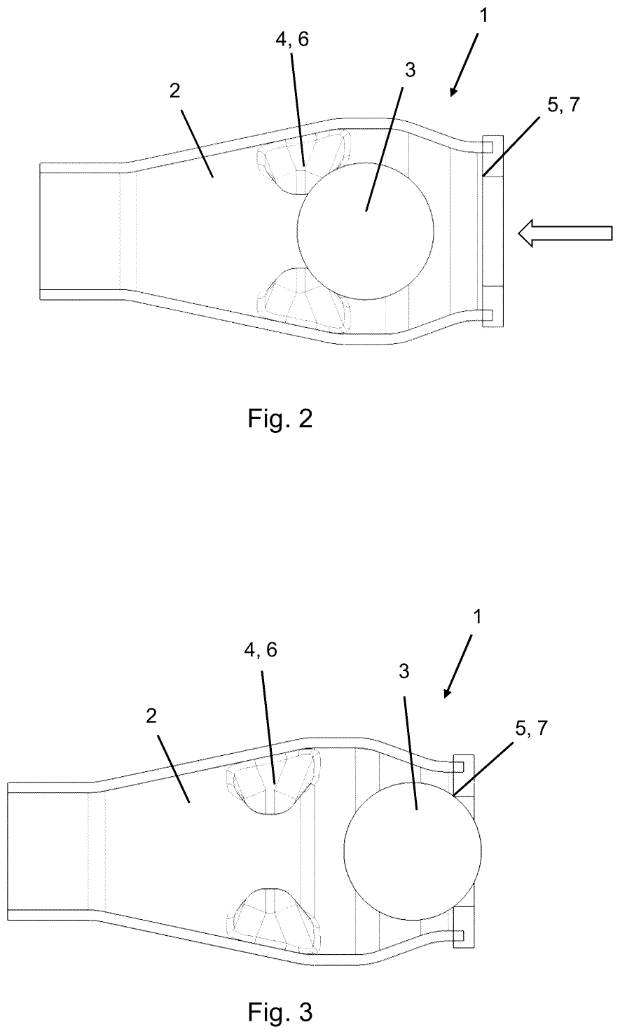

FIG. 2 shows the blocking body 3 in the passage position. The blocking body 3 rests against the projections 6, which form the retaining element 4. The flow direction of the fluid is indicated by the arrow. The fluid can flow around the blocking body 3 through the flow channel 2.

FIG. 3 shows the blocking body 3 in the blocking position. The blocking body 3 rests against the sealing projection 7 in a sealing manner and thus blocks the flow channel 2, so that the fluid is prevented from flowing through.

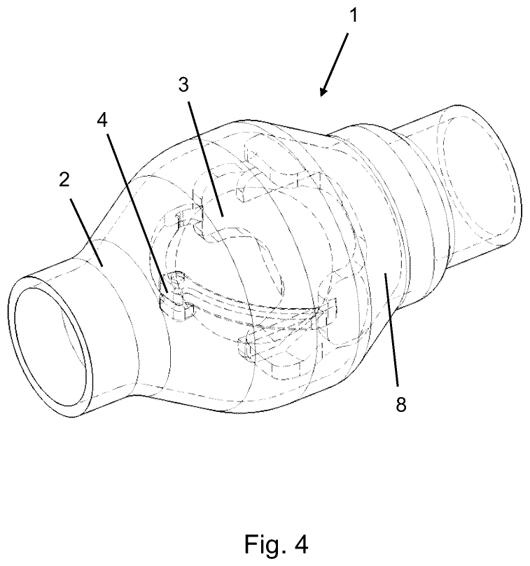

FIGS. 4 to 6 show a second embodiment of a check valve 1. In this embodiment, the blocking body 3 has also a spherical form. The check valve 1 comprises a cage 8, wherein the cage 8 forms the retaining element 4 and the blocking body seat 5. The cage 8 is connected to the flow channel 2 with a materially bond. The cage 8 is connected in sections around the outer circumference to the inside of the flow channel 2, wherein the connection between the cage 8 and the flow channel 2 is formed in a sealing manner, so that no fluid can pass between the outside of the cage 8 and the inside of the flow channel 2 in the region of the blocking body seat 5.

The cage 8 is inserted into the flow channel 2 as a separate component. The cage 8 was inserted into the flow channel 2 during the manufacturing process of the flow channel 2. The cage 8 accommodates the blocking body 3, and the cage 8 and the blocking body 3 form a structural unit. The structural unit is formed as an insert and was inserted into the blow mold before the blow molding process. In this case, the structural unit was inserted into the preform of the flow channel 2 and then the flow channel 2 was formed by blow molding, so that the structural unit is directly integrated into the flow channel 2. During blow molding, the cage 8 was molded to the flow channel 2. The cage 8 is connected to the flow channel 2 via a materially bond and is arranged in a loss-proof manner in the flow channel 2.

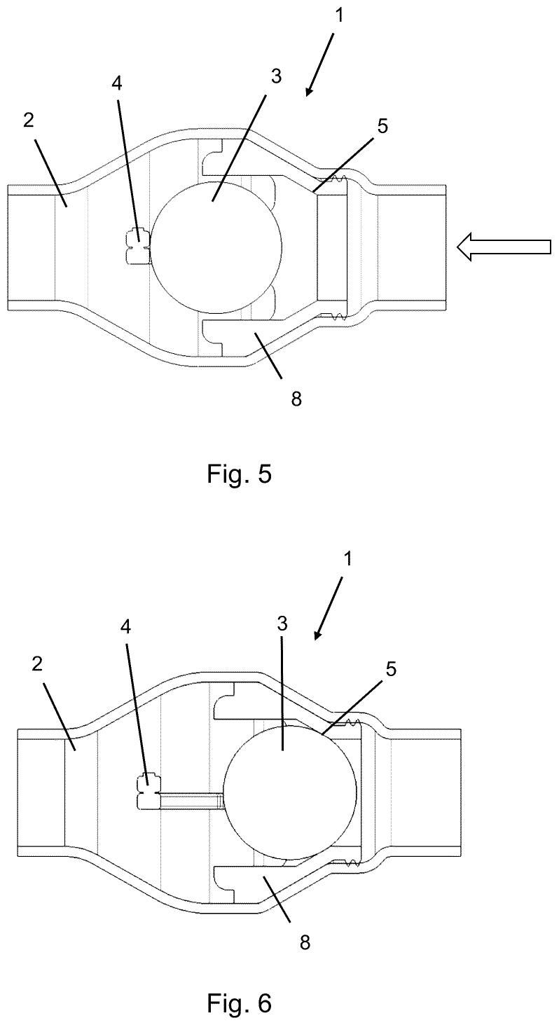

FIG. 5 shows the blocking body 3 in the passage position. The blocking body 3 rests against the bow-shaped retaining element 4, thereby limiting the movement of the blocking body 3 in the longitudinal direction of the flow channel 2. The flow direction of the fluid is indicated by the arrow. The fluid can flow around the blocking body 3 through the flow channel 2.

FIG. 6 shows the blocking body 3 in the blocking position. The blocking body 3 rests against the cage 8 in a sealing manner and thus blocks the flow channel 2, so that the fluid is prevented from flowing through.

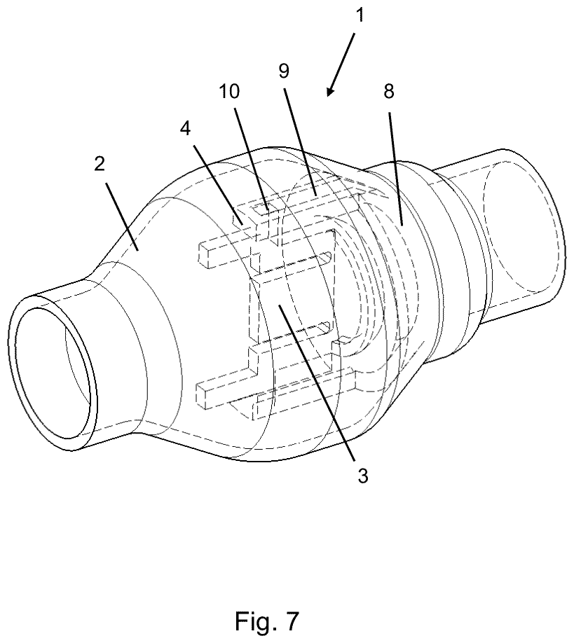

FIGS. 7 to 9 show a third embodiment of a check valve 1. In this embodiment, the blocking body 3 has an umbrella-like shape. The check valve 1 comprises a cage 8, wherein the cage 8 comprises the retaining element 4 and the blocking body seat 5. The cage 8 is connected to the flow channel 2 with a materially bond by welding. In doing so, the cage 8 is connected around the outer circumference to the inside of the flow channel 2, wherein the connection between the cage 8 and the flow channel 2 is formed in a sealing manner, so that no fluid can pass between the outside of the cage 8 and the inside of the flow channel 2 in the region of the blocking body seat 5. In the blocking position, no fluid can therefore flow through check valve 1.

The cage 8 is inserted into the flow channel 2 as a separate component. The cage 8 was inserted into the flow channel 2 during the manufacturing process of the flow channel 2. The cage 8 is arranged in a loss-proof manner in the flow channel 2.

The cage 8 accommodates the blocking body 3, and the cage 8 and the blocking body 3 form a structural unit. The structural unit is formed as an insert and was inserted into the blow mold before the blow molding process and molded onto the flow channel 2 during the blow molding process.

In addition, the cage 8 has two guide sections 9, which are formed to guide a movement of the blocking body 3 in the longitudinal direction of the flow channel 2. The guide sections 9 can prevent or at least reduce jamming and radial deviation of the blocking body 3 relative to the blocking body seat 5. The guide sections 9 are each formed by a recess arranged in the cage 8, in which guide sockets 10 arranged on the blocking body 3 can engage.

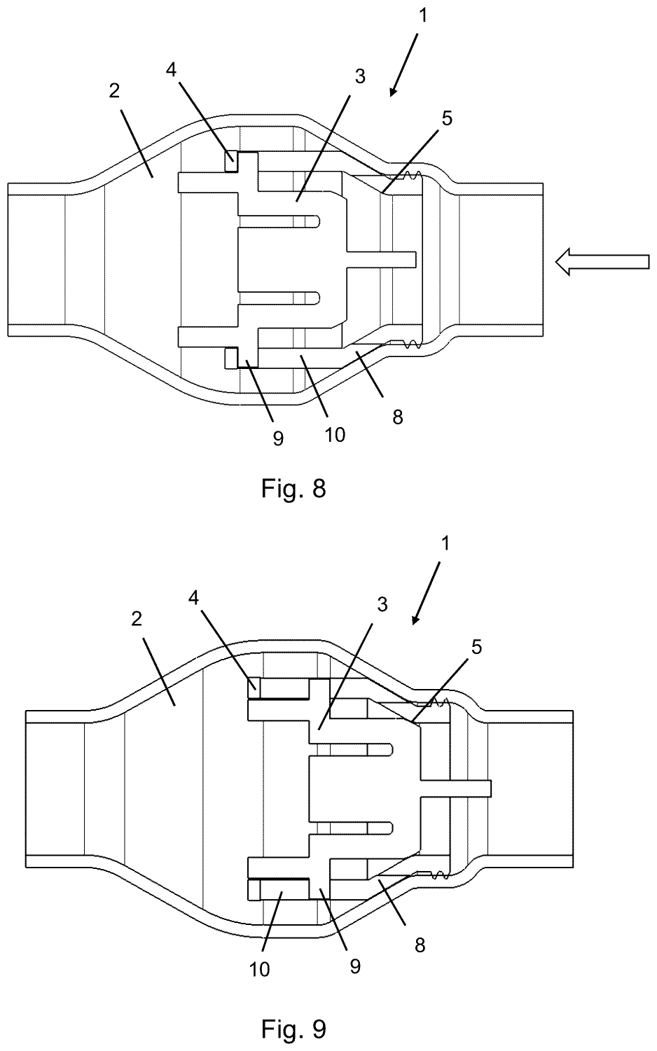

FIG. 8 shows the blocking body 3 in the passage position. The blocking body 3 rests against the retaining element 4 in the end position of the guide sections 9 assigned to the passage position, which limits the movement of the blocking body 3 in the longitudinal direction of the flow channel 2. The flow direction of the fluid is indicated by the arrow. The fluid can flow around the blocking body 3 through the flow channel 2.

FIG. 9 shows the blocking body 3 in the blocking position. The blocking body 3 rests against the cage 8 in a sealing manner and thus blocks the flow channel 2, so that the fluid is prevented from flowing through.

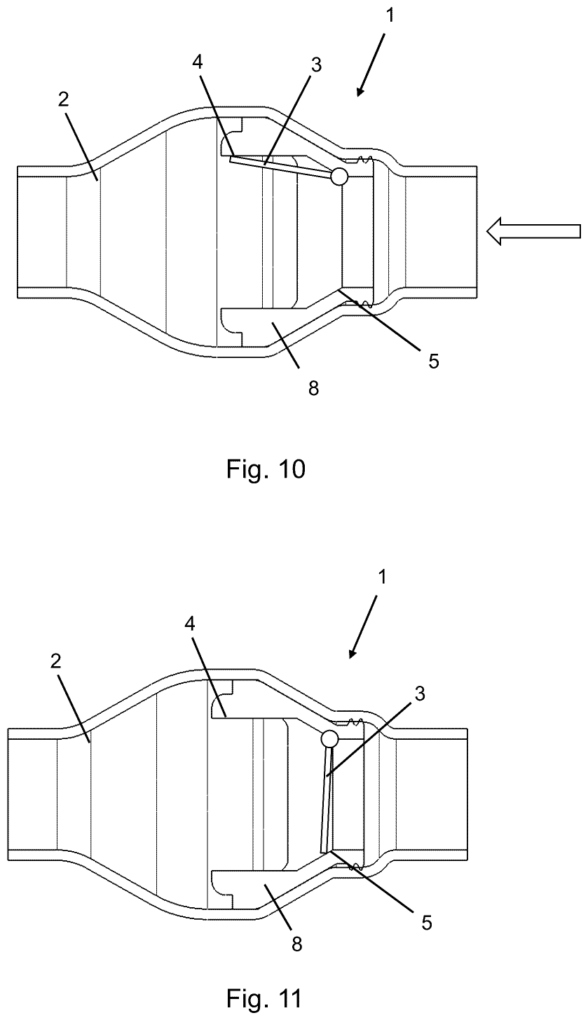

The FIGS. 10 and 11 show a fourth embodiment of a check valve 1. The check valve 1 comprises a cage 8, wherein the cage 8 comprises the blocking body seat 5. In this embodiment, the blocking body 3 is formed as a flap and is connected to the cage 8 via a hinge.

The blocking body 3 can be moved by a pressure difference of the fluid flowing through the flow channel 2. Depending on the flow direction, different pressure differences can exist at the blocking body 3, so that the blocking body 3 can be moved to the blocking position or the passage position. In the passage position, the blocking body 3 is rotated about the hinge, so that the side of the blocking body 3 facing away from the hinge is spaced apart from the blocking body seat 5, so that fluid can flow through the flow channel 2. In the blocking position, the blocking body 3 is rotated about the hinge, so that the blocking body 3 completely rests against the blocking body seat 5 in a sealing manner and closes the flow channel 2.

The cage 8 is connected to the flow channel 2 with a materially bond by welding. In doing so, the cage 8 is connected around the outer circumference to the inside of the flow channel 2, wherein the connection between the cage 8 and the flow channel 2 is formed in a sealing manner, so that no fluid can pass between the outside of the cage 8 and the inside of the flow channel 2 in the region of the blocking body seat 5. In the blocking position, no fluid can therefore flow through check valve 1.

The cage 8 is inserted into the flow channel 2 as a separate component. The cage 8 was inserted into the flow channel 2 during the manufacturing process of the flow channel 2. The cage 8 is arranged in a loss-proof manner in the flow channel 2.

The cage 8 accommodates the blocking body 3, and the cage 8 and the blocking body 3 form a structural unit. The structural unit is formed as an insert and was inserted into the blow mold before the blow molding process and molded onto the flow channel 2 during the blow molding process.

FIG. 10 shows the blocking body 3 in the passage position. The blocking body 3 is swung open and opens the flow channel 2. The blocking body 3 rests against the retaining element 4, thereby limiting the movement of the blocking body 3. The flow direction of the fluid is indicated by the arrow. The fluid can flow through the flow channel 2.

FIG. 11 shows the blocking body 3 in the blocking position. The blocking body 3 rests against the cage 8 in a sealing manner and thus blocks the flow channel 2, so that the fluid is prevented from flowing through.

1. A check valve, comprising:
a flow channel through which a fluid can flow; and
at least one blocking body, wherein the blocking body is arranged movably in the flow channel, wherein the blocking body is movable between a blocking position and a passage position,
wherein a retaining element and a blocking body seat are arranged in the flow channel, wherein the retaining element limits a movement of the blocking body,
wherein the blocking body moves into the blocking position in a first flow direction of the fluid, so that the blocking body rests against the blocking body seat in a sealing manner and closes the flow channel, and wherein the blocking body moves in a second flow direction of the fluid into the passage position and opens the flow channel,
wherein the flow channel extends at least around the blocking body, the retaining element and the blocking body seat and is formed in one piece and in a materially integral manner.

2. The check valve according to claim 1, wherein the flow channel is formed as a blow-molded part.

3. The check valve according to claim 1, wherein at least one restoring spring is arranged on the blocking body, the at least one restoring spring exerting a restoring force on the blocking body, wherein the restoring force acts in the direction from the retaining element towards the blocking body seat.

4. The check valve according to claim 1, wherein the retaining element and/or the blocking body seat is formed from the flow channel in one piece and in a materially integral manner.

5. The check valve according to claim 1, wherein the retaining element has at least one projection projecting into the interior of the flow channel.

6. The check valve according to claim 1, wherein the blocking body seat has a circumferential sealing projection projecting into the interior of the flow channel.

7. The check valve according to claim 1, wherein the check valve comprises a cage, wherein the cage comprises the retaining element.

8. The check valve according to claim 7, wherein the cage comprises the blocking body seat.

9. The check valve according to claim 7, wherein the cage is inserted into the flow channel as a separate component.

10. The check valve according to claim 7, wherein the cage accommodates the blocking body and the cage and the blocking body form a structural unit.

11. The check valve according to claim 7, wherein the cage has at least one guide section which is formed to restrict a movement of the blocking body.

12. The check valve according to claim 7, wherein the blocking body is hingedly connected to the cage.

13. A pipe with at least one check valve according to claim 1, wherein the pipe and the flow channel are formed in a materially integral manner and in one piece.

14. The pipe according to claim 13, wherein the check valve is formed in a section of the pipe.

15. A temperature control circuit comprising at least one check valve according to claim 1.
